(19) United States
(12) Patent Application Publication
(10) Pub. No.: US 2007/0221739 A1
(43) Pub. Date: Sep. 27, 2007

(54) Method and apparatus to remotely detect and manage temperature of a human body

(75) Inventor: James Kazu Kochuba, Raleigh, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/385,342

(22) Filed: Mar. 21, 2006

(51) Int. Cl. F23N 3/04; G01M 1/38

(52) U.S. Cl. 236/1 G; 700/276

(57) ABSTRACT

A computer implemented method, apparatus, and computer usable program code for adjusting a temperature of a human body is shown. A user selects a selected temperature that the user would like the user's body to be. When the temperature is beyond the selected temperature range, a vent heat is applied. A determination whether the temperature has reached the selected temperature is made. If so, the vent heat is stopped or reduced.

### BACKGROUND OF THE INVENTION

1. Field of the Invention

The present invention relates generally to heating, ventilation, and air conditioning control systems. More specifically, the present invention relates to a computer implemented method, apparatus, and computer usable code to adjust heating and cooling vents based on time and a remotely detected user body temperature.

2. Description of the Related Art

A heat transfer factor is an indication of the level of heat transfer to air surrounding a user. The heat transfer factor is based on parameters such as the exit temperature of air from the vent, distance from the vent, and the volume of air moving through the vent. For example, the heat transfer factor is high when a body is near a vent. The heat transfer factor is high when a heat transfer system output produces a high volume of heated or cooled air.

Air flow may be measured in normal liters per minute. A normal liter is a unit of mass for gases equal to the mass of 1 liter (0.035 3147 ft3) at a pressure of 1 atmosphere and at a standard temperature. Delta temperature is the difference between the temperature of the ambient air, and the air flowing at the exit of a vent, expressed as an absolute value. Delta temperature is measured in centigrade units. A vent distance is the distance a person is from a vent. The heat transfer factor is expressed, for example, by an equation that is proportional to an inverse square of the distance: n*t/d², wherein n measures normal liters per minute, t measures delta temperature, and d measures the distance. Thus, for an air flow of 100 normal liters per minute, at a delta temperature of 10 centigrade at 1 meter, 100*10/1² yields 1,000 nl*C/m² minute. Any heat transfer factor above, for example, 200 nl*C/m² minute is a high heat transfer factor. Any heat transfer factor at or below, for example, 200 nl*C/m² minute is a low heat transfer factor.

Heating and cooling systems of the past operate according to a thermostat, which typically operates in two states: vent heat on; and vent heat off. A vent heat is a movement of gases, under pressure, through a vent opening, wherein the gases are at a temperature different from the ambient air. Thus, vent heat may be a movement of gasses that are cooler than an ambient air. Alternatively, vent heat may be a movement of gasses that are warmer than an ambient air. Unfortunately, for small environments that are exposed to rapidly changing sunlight, for example, an automobile, a user may alternately wish to be heated and cooled, depending on whether sunlight is falling on the user.

Moreover, a user, regardless of the ambient air temperature, may have a body temperature that is elevated or depressed below a level that the user feels comfortable. Consequently, it is helpful that any temperature measurements be made of the user's body and use that reading or measurement to control a heating, ventilation and air-conditioning system's vent heat.

Furthermore, given a possibly accurate location of the user and of the user's body temperature, it would also be nice to diminish the flow of air to the user if the user is near a vent, or increase the flow of air to the user if the user is far from a vent. Moderating the heat flow to or from a user in accordance with a heat factor will permit the user to reach and maintain a preferred temperature.

### BRIEF SUMMARY OF THE INVENTION

The present invention provides a computer implemented method, apparatus, and computer usable program code for regulating air in an environment. A system measures a temperature of a human body with a remote temperature monitoring transducer to form a reading. The system determines whether the temperature is beyond a selected temperature range or a temperature for which a user is comfortable. The system applies a vent heat based on the temperature responsive to the temperature being beyond the selected temperature. The system determines whether the temperature is within the selected temperature. In addition, the system inhibits a vent heat based on the temperature, responsive to the temperature being within the selected temperature.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a heating, ventilation, and air conditioning system in accordance with an exemplary embodiment of the present invention;

FIG. 2 shows a data processing system in accordance with an exemplary embodiment of the present invention;

FIG. 3 shows a detailed data processing system in accordance with an exemplary embodiment of the present invention; and

FIG. 4 shows a flowchart in accordance with an exemplary embodiment of the present invention.

### DETAILED DESCRIPTION OF THE INVENTION

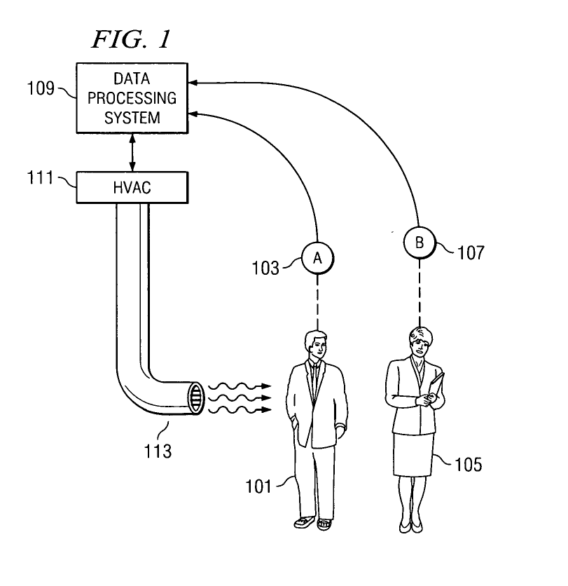

With reference now to the figures and in particular with reference to FIG. 1 shows a heating, ventilation, and air conditioning system in accordance with an exemplary embodiment of the present invention. First user 101 is located in an environment directly in front of remote temperature monitoring transducer A 103. Second user 105 is located in front of or within range of remote temperature monitoring transducer B 107.

In these illustrative examples, a remote temperature monitoring transducer is a device that detects the temperature or radiant emissions on a surface located a distance from the remote temperature monitoring transducer. A remote temperature monitoring transducer includes, for example, devices such as thermopiles, thermal vision systems, and laser temperature readers. Remote temperature monitoring transducer A 103, and remote temperature monitoring transducer B 107 may be monitored by data processing system 109. Data processing system 109 controls and may be responsive to heating, ventilation, and air conditioning unit (HVAC) 111. Heating, ventilation, and air conditioning unit 111 provides heating and cooling through one or more vents, for example, vent 113. Vent 113 is a source of air that may be heated or cooled by HVAC 111. It is appreciated that devices, other than a vent, may be substituted for a vent without implementing a system outside the embodiments of the present invention. For example, a system that applies only heat may make airflow through the vent. Radiant heat devices may be used in place of a vent. Even conductive heating and cooling, as may occur by running fluids through floor tiles, may operate as equivalent devices as vent 113.

First user 101 is located nearer to vent 113 relative to second user 105 is located farther from vent 113 relative to first user 101. First user 101 is in an environment where vent heat from has a greater impact on first user 101's ambient temperature and therefore on his temperature. The degree to which vent 113 impacts a particular user's temperature is called a heat transfer factor. A heat transfer factor is an indication of the level of heat transferred to air surrounding a user. The heat transfer factor is based on parameters such as the exit temperature of air from the vent, distance of a user from the vent, and the volume of air moving through the vent. Second user 105 is in an environment having a low heat transfer factor. By comparison, first user 101 is in an environment having a high heat transfer factor. Consequently, second user 105 may take longer to reach a comfortable temperature as compared to first user 101.

Thus, illustrative embodiments of the present invention show a computer implemented method, apparatus, and computer usable program code for adjusting a temperature of a human body. A system regulates a user's temperature of the user's body based on the positioning of a user and the relative heat factor of a vent. The temperature operates as a way to govern the application of heating or cooling from a vent.

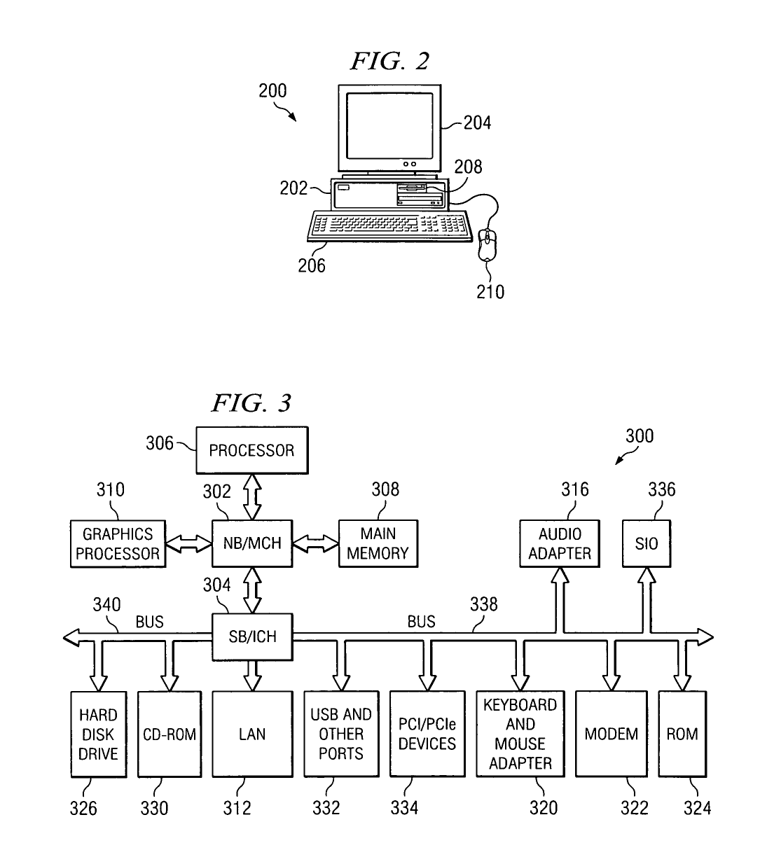

FIG. 2 is a pictorial representation of a data processing system in which the aspects of illustrative embodiments of the present invention may be implemented. Computer 200 is an example of a data processing system that may be used to implement data processing system 109 in FIG. 1. Computer 200 is depicted which includes system unit 202, video display terminal 204, keyboard 206, storage devices 208, which may include floppy drives and other types of permanent and removable storage media, and mouse 210. Additional input devices may be included with personal computer 200, such as, for example, a joystick, touchpad, touch screen, trackball, microphone, and the like. Computer 200 can be implemented using any suitable computer, such as an IBM® eServer™ computer or IntelliStation computer, which are products of International Business Machines Corporation, located in Armonk, N.Y. Although the depicted representation shows a computer, other embodiments of the present invention may be implemented in other types of data processing systems, such as a network computer. Computer 200 also preferably includes a graphical user interface (GUI) that may be implemented by means of systems software residing in computer readable media in operation within computer 200.

With reference now to FIG. 3, a block diagram of a data processing system is shown in which aspects of the present invention may be implemented. Data processing system 300 is an example of a computer, such as computer 200 in FIG. 2, in which code or instructions implementing the processes of the present invention may be located. In the depicted example, data processing system 300 employs a hub architecture including a north bridge and memory controller hub (NB/MCH) 302 and a south bridge and input/output (I/O) controller hub (SB/ICH) 304. Processor 306, main memory 308, and graphics processor 310 are connected to north bridge and memory controller hub 302. Graphics processor 310 may be connected to the MCH through an accelerated graphics port (AGP), for example.

In the depicted example, local area network (LAN) adapter 312 connects to south bridge and I/O controller hub 304 and audio adapter 316, keyboard and mouse adapter 320, modem 322, read only memory (ROM) 324, hard disk drive (HDD) 326, CD-ROM drive 330, universal serial bus (USB) ports and other communications ports 332, and PCI/PCIe devices 334 connect to south bridge and I/O controller hub 304 through bus 338 and bus 340. PCI/PCIe devices may include, for example, Ethernet adapters, add-in cards, and PC cards for notebook computers. PCI uses a card bus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. Super I/O (SIO) device 336 may be connected to south bridge and I/O controller hub 304.

An operating system runs on processor 306 and coordinates and provides control of various components within data processing system 300 in FIG. 3. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 300 (Java is a trademark of Sun Microsystems, Inc. in the United States, other countries, or both).

Instructions for the operating system, the object-oriented programming system, and applications or programs are located on storage devices, such as hard disk drive 326, and may be loaded into main memory 308 for execution by processor 306. The processes of the present invention are performed by processor 306 using computer usable program code, which may be located in a memory such as, for example, main memory 308, ROM 324, or in one or more peripheral devices.

Those of ordinary skill in the art will appreciate that the hardware in FIGS. 2-3 may vary depending on the implementation. Other internal hardware or peripheral devices, such as flash memory, equivalent non-volatile memory, or optical disk drives and the like, may be used in addition to or in place of the hardware depicted in FIGS. 2-3. Also, the processes of the present invention may be applied to a multiprocessor data processing system.

In some illustrative examples, data processing system 300 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course, the bus system may be implemented using any type of communication fabric or architecture that provides for a transfer of data between different components or devices attached to the fabric or architecture. A communications unit may include one or more devices used to transmit and receive data, such as a modem or a network adapter. A memory may be, for example, main memory 308 or a cache such as found in north bridge and memory controller hub 302. A processing unit may include one or more processors or CPUs. The depicted examples in FIGS. 2-3 and above-described examples are not meant to imply architectural limitations. For example, data processing system 300 also may be a device specifically designed to control an HVAC system, such as HVAC 111 in FIG. 1.

A remote temperature monitoring transducer is a device that detects the temperature or radiant emissions of a surface located a distance from the remote temperature monitoring transducer. A remote temperature monitoring transducer includes devices such as thermopiles, thermal vision systems, and laser temperature readers. For example, remote temperature monitoring transducer 103 of FIG. 1 may be a laser temperature reader, which points in the direction of first user 101. A temperature of a human body is a temperature measured with a remote temperature monitoring transducer.

The temperature measured may be of surfaces of items worn by a person. Such surfaces include make-up, sweat, tears, bandages, and articles of clothing, among other things. The temperature measured may be different from a temperature that a person measures with a linear thermometer. A selected temperature range is a temperature a person presets to reflect the temperature a person prefers to be at, or to compensate for any perceived errors that may be present in the system. The selected temperature range may be, for example, a temperature that a healthy human being exhibits while at rest. One selected temperature range may be the temperature range beginning at 97.8 degrees Fahrenheit through the temperature of 99.1 degrees Fahrenheit. A system designer may establish a selected temperature range as a default selected temperature range, wherein a user may change the selected temperature range as desired. A user may select other selected temperature ranges, based on what the user perceives as “normal.”

An environment is a volume of space where a remote temperature monitoring transducer is effective at measuring a body temperature of a user. Such a volume may roughly correspond to a volume of space within the path of gasses that exit from a vent. A sleeping environment is a volume of space in and around a bed or other sleeping apparatus. A vehicle is a device for transporting people. A vehicle environment is an environment inside a vehicle, for example, a car. A user in a car is particularly susceptible to body temperature changes as the car heats and cools after starting. In addition, sunlight more often falls on a user while seated in a car.

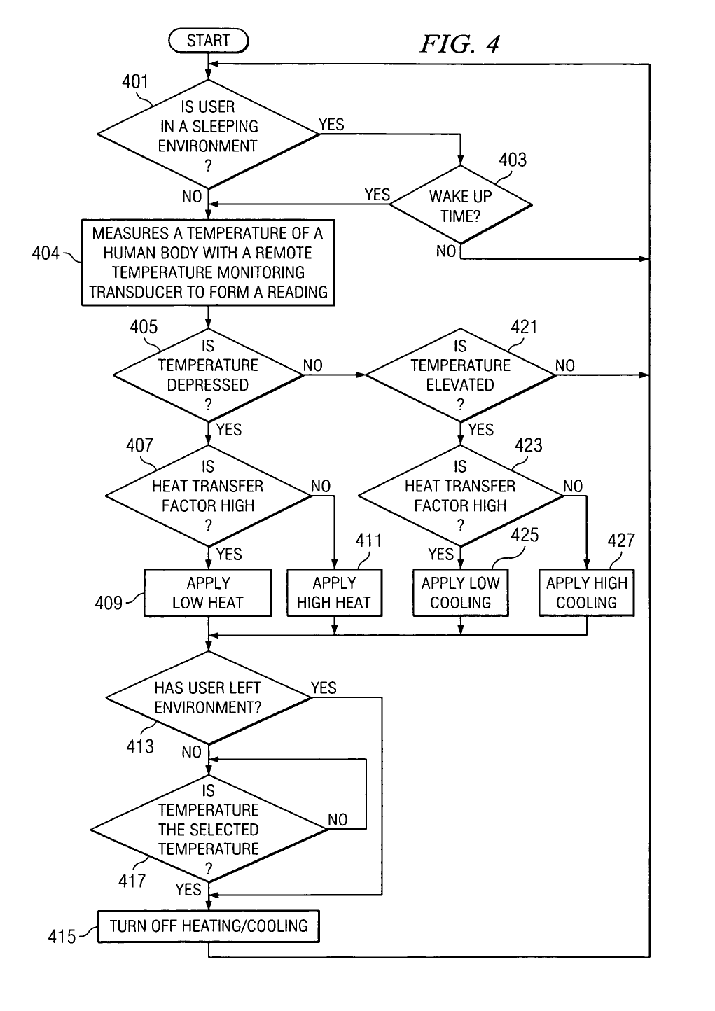

FIG. 4 is a flowchart showing a process to regulate a user's body temperature in accordance with an exemplary embodiment of the present invention. The steps of the flowchart may be executed by a data processing system, for example, data processing 109 of FIG. 1.

A data processing system determines if a user is in a sleeping environment (step 401). The processing system makes a determination that a user is in a sleeping environment by determining that the user is present. Remote temperature monitoring transducer, for example, may produce a signal indicating the presence of a user within an environment, for example, a sleeping environment.

Provided that the data processing system determines that a user is in a sleeping environment, the data processing system determines whether a wake-up-time has occurred (step 403). A wake-up-time is a time, preset by a human or user, that the user desires to be awoken. A wake-up-time should not be confused with an actual state of mind that a user may have during the wake-up-time. The wake-up-time is determined only at the time, that the user enters a wake-up-time into a data processing system. In the event that the data processing system made a negative determination at step 401, processing is the same as if there was an affirmative exit from both steps 401 and 403. In other words, the data processing system restores a user to the selected temperature.

The data processing system measures a temperature of a human body with a remote temperature monitoring transducer to form a reading (step 404). A reading is a measurement made by a remote temperature monitoring transducer. The data processing system determines if the reading indicates the temperature is beyond the selected temperature range. Since the selected temperature range is a range, ‘beyond’ or ‘outside of’ indicates that a temperature reading is outside the range. Like any range, there is a high value to the range or a low value to the range. In this context, a high selected temperature is a high value. A low selected temperature is a low value. In some instances, the high value may be the same as the low value. For example, the data processing system determines whether a user's temperature is a depressed temperature (step 405). A temperature is a depressed temperature if the user's temperature, as sensed by a remote temperature sensing transducer, detects that the temperature is below the selected temperature range.

An embodiment of the present invention may permit a user to adjust the threshold that separates the high heat transfer factor range from the low heat transfer range. A default setting may be any heat transfer factor above, for example, 200 nl*C/m² minute is a high heat transfer factor. As a result, any heat transfer factor at or below, for example 200 nl*C/m² minute is a low heat transfer factor.

The data processing system determines if a heat transfer factor is high for the environment that the user is in (step 407). If the heat transfer factor is high, the data processing system controls the heating, ventilation, and air conditioning unit to apply a low heat (step 409). Otherwise, the data processing system commands the heating, ventilation, and air conditioning unit to apply a high heat (step 411).

The data processing system may determine periodically whether the user has left the environment (step 413). If the user has left the environment, the data processing system turns off the heating and cooling operated by the heating, ventilation, and air conditioning unit (step 415). However, if the user has not left the environment, the data processing system determines if the temperature of the human body is the selected temperature (step 417) or whether the user has left the environment (step 413). If not, the data processing system may continuously determine if the user has reached the selected temperature (step 417). Eventually there is a positive determination that the user has reached the selected temperature and the data processing system continues to step 415. Once the data processing system turns off heating or cooling, the steps may repeat themselves.

In the event that a negative determination was made at step 405 the data processing system determines if a user's temperature is an elevated temperature (step 421). The data processing system makes this determination in relation to the selected temperature range. That is, the temperature is elevated if the temperature is above the selected temperature. The data processing system may make a positive determination to step 421. The positive determination results in the data processing system determining if there is a high heat transfer factor in relation to the vent heat and the user's environment (step 423). If so, the data processing system commands the heating, ventilation, and air conditioning unit to apply low cooling (step 425). Otherwise, the data processing system applies high cooling (step 427). As in the cases where heat was applied the data processing system continues to step 413.

A feature of the system just described, is that a reading may initially show a temperature is depressed and pass through the affirmative branch of step 405. The system may satisfactorily increase a user body temperature and accomplish an affirmative exit from step 417, wherein the data processing system tests to see if the user is at the selected temperature range. Still further, temperatures may rise between dawn and noon, the user's body may reach a new temperature wherein the temperature is elevated. Thus, the system passes through the affirmative branch of step 421, wherein the system tests to see if the user's temperature is elevated. The foregoing series of temperatures shows the user being below, and beyond, the selected temperature range. The user moves to within the selected temperature range. The user finally moves to above, and beyond, the selected temperature range.

Thus, the aspects of the present invention provide a computer implemented method, apparatus, and computer usable program code to remotely detect and manage a temperature of a human body. A user's wake-up-time may trigger operation of the temperature regulation system. Initially, the system measures a temperature of a human body. Depending on whether the user's actual body temperature is elevated or depressed, cooling or heating is applied. When a vent heat is applied, the system determines if a heat transfer factor is high or low, and adjusts the flow of heat from the system accordingly. Consequently, heating and cooling is not directed at making the zone near a thermostat pleasant, but rather, the illustrative embodiments of the present invention apply heating or cooling in the correct amounts to make the environment around the user, and thus the user, comfortable.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for regulating air temperature in an environment comprising:
measuring a temperature of a human body with a remote temperature monitoring transducer to form a reading;
determining whether the reading is outside of a selected temperature range;
applying a vent heat based on the temperature, responsive to the temperature being outside of the selected temperature range;
determining whether the temperature is within the selected temperature range; and
inhibiting the vent heat in response to the temperature being within the selected temperature range.

2. The computer implemented method of claim 1, further comprising:
determining whether the environment is a sleeping environment; and
determining whether the temperature is in the environment, wherein the step of applying the vent heat is based on a heat transfer factor, and wherein the step of measuring the temperature is responsive to the user being in the sleeping environment and a wake-up-time occurring.

3. The computer implemented method of claim 2, further comprising:
determining whether a heat transfer factor is high, wherein the applying step is based on the heat transfer factor.

4. The computer implemented method of claim 2, further comprising:
determining whether the user has left the environment, wherein the environment is a space wherein the temperature may be measured.

5. The computer implemented method of claim 1, further comprising:
determining whether a heat transfer factor is high, wherein the applying step is based on the heat transfer factor.

6. The computer implemented method of claim 1, further comprising:
determining whether the user has left the environment, wherein the environment is a space wherein the temperature may be measured.

7. The computer implemented method of claim 6, wherein the environment is inside a vehicle.

8. A computer program product comprising a computer usable medium having computer usable program code for regulating air temperature in an environment, said computer program product including;
computer usable program code for measuring a temperature of a human body with a remote temperature monitoring transducer to form a reading;
computer usable program code for determining whether the temperature is outside of a selected temperature range;
computer usable program code for applying a vent heat in response to the temperature being outside of the selected temperature range;
computer usable program code for determining whether the temperature is within the selected temperature range; and
computer usable program code for inhibiting the vent heat in response to the temperature being within the selected temperature range.

9. The computer program product of claim 8, further comprising:
computer usable program code for determining whether the environment is a sleeping environment; and
computer usable program code for determining whether the temperature is in the environment, wherein the computer usable program code for applying is based on a heat transfer factor, and wherein the computer usable program code for measuring the temperature is responsive to the user being in the sleeping environment and a wake-up-time occurring.

10. The computer program product of claim 9, further comprising:
computer usable program code for determining whether a heat transfer factor is high, wherein the computer usable program code for applying is based on the heat transfer factor.

11. The computer program product of claim 9, further comprising:
computer usable program code for determining whether the user has left the environment, wherein the environment is a space wherein the temperature may be measured.

12. The computer program product of claim 8, further comprising:
computer usable program code for determining whether a heat transfer factor is high, wherein the computer usable program code for applying is based on the heat transfer factor.

13. The computer program product of claim 8, further comprising:
computer usable program code for determining whether the user has left the environment, wherein the environment is a space wherein the temperature may be measured.

14. The computer program product of claim 13, wherein the vent heat is a movement of gasses that are cooler than an ambient air.

15. A data processing system comprising:
a bus;
a storage device connected to the bus, wherein computer usable code is located in the storage device;
a communication unit connected to the bus;
a processing unit connected to the bus, wherein the processing unit executes the computer usable code to regulate air temperature in an environment, the processing unit further executes the computer usable code to: measuring a temperature of a human body with a remote temperature monitoring transducer to form a reading; determine whether the temperature is outside of a selected temperature range; apply a vent heat based on the temperature, responsive to the temperature being outside of the selected temperature range; determine whether the temperature is within the selected temperature range; and inhibit the vent heat in response to the temperature being within the selected temperature range.

16. The data processing system of claim 15, wherein the processing unit further executes the computer usable code to: determine whether the environment is a sleeping environment; determine whether the temperature is in the environment, wherein the step of applying the vent heat is based on a heat transfer factor, and wherein the computer usable code to measure the temperature is responsive to the user being in the sleeping environment and a wake-up-time occurring.

17. The data processing system of claim 16, wherein the processing unit further executes the computer usable code to: determine whether a heat transfer factor is high, wherein the computer usable code to apply is based on the heat transfer factor.

18. The data processing system of claim 16, wherein the processing unit further executes the computer usable code to: determine whether the user has left the environment, wherein the environment is a space wherein the temperature may be measured.

19. The data processing system of claim 15, wherein the processing unit further executes the computer usable code to: determine whether a heat transfer factor is high, wherein the applying step is based on the heat transfer factor.

20. The data processing system of claim 15, wherein the processing unit further executes the computer usable code to: determine whether the user has left the environment, wherein the environment is a space wherein the temperature may be measured.
